(19) United States
(12) Patent Application Publication
(10) Pub. No.: US 2003/0194127 A1
(43) Pub. Date: Oct. 16, 2003

(54) Chromaticity histogram that is weighted for brightness

(76) Inventors: Paul M. Hubel, Mt. View, CA (US); Graham D. Finlayson, Taverham (GB); Steven D. Hordley, Old Costessey (GB)

Correspondence Address: HEWLETT-PACKARD COMPANY, Intellectual Property Administration, P.O. Box 272400, Fort Collins, CO, 80527-2400, US

(21) Appl. No.: 10/119,795

(22) Filed: Apr. 10, 2002

(51) Int. Cl. G06K 9/00

(52) U.S. Cl. 382/165; 382/170

(57) ABSTRACT

A white point of scene illumination is determined by using a chromaticity histogram that is weighted for brightness.

### BACKGROUND

A human observer can view a scene under a variety of different illuminants, yet still see the same range of colors. For example, a white piece of paper remains resolutely white independent of the color of light under which it is viewed. This psycho-visual effect is referred to as “color constancy.”

In contrast, color imaging systems are less color constant in that they will often infer the color of the scene illuminant incorrectly. For example, a digital camera captures an image of an indoor scene under a reddish tungsten illumination. Since the light entering the camera is this tungsten illumination reflected from the objects in the scene, all objects in the scene will be recorded as redder than they would be had the illuminant been a whitish fluorescent light. This change in color is at odds with what a human observes (the human perception of the colors of the objects is relatively stable, even if the illuminant is switched between tungsten and fluorescent).

Color appearance models can be used to ensure color constancy in images produced by the imaging systems. That is, the color appearance models can ensure that the colors in the scene appear the same, regardless of the illumination.

However, these models depend upon knowledge of the white point of the image scene. If the imaging system does not measure the white point directly, the white point is estimated.

A number of techniques for estimating the white point have been proposed. One such technique, described in U.S. Pat. No. 6,038,339, uses a binarized chromaticity histogram. Each entry in the binarized histogram has a value of zero or one.

### SUMMARY

According to one aspect of the present invention, a white point of scene illumination is determined by using a chromaticity histogram that is weighted for brightness. Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a method according to an embodiment of the present invention.

FIG. 2 is an illustration of a chromaticity histogram.

FIG. 3 is an illustration of an apparatus according to an embodiment of the present invention.

### DETAILED DESCRIPTION

As shown in the drawings for the purpose of illustration, the present invention is embodied in a method and system for estimating a white point of a scene illumination in a digital image. The method and system use a chromaticity histogram that is weighted for brightness. Each entry in the chromaticity histogram represents a likelihood that the associated chromaticity corresponds to a white surface. Entries corresponding to brighter pixels may be assigned higher weights. Bright pixels in the image convey useful information about the color of the scene illuminant. Brightness information is useful for illuminant estimation because it provides clues as to the location of spectrally non-selective surfaces. Additionally, brighter pixels can convey more reliable information in that they are less affected by many type of image noise.

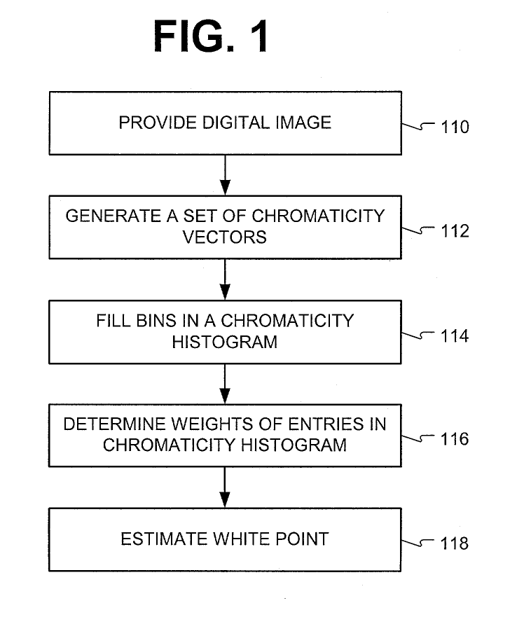

Reference is made to FIG. 1. A scene is provided by a digital camera or other imaging system having a sensor array (110). The scene is illuminated by one or more sources of light. The light provided by the one or more light sources will be referred to collectively as an “illuminant.”

The sensor array outputs a sensor image. In the spatial domain, each pixel is represented by an n-bit word. In a typical 24-bit word representing RGB color space, for instance, eight bits represent a red component, eight bits represent a green component and eight bits represent a blue component.

The pixels in the image are coded as two-dimensional chromaticity vectors (112). Resulting is a set of chromaticity vectors for the image. For example, the chromaticity vector (x,y) of a pixel may be represented as

$$( x = \frac{R}{R + G + B} , y = \frac{G}{R + G + B} ) ,$$

where R, G and B are red, green and blue components of the pixel. In assignee's U.S. Ser. No. ______ (attorney docket no. 100203092-1) the chromaticity vector of a pixel may be represented as

$$[ x = \frac{{x}_{1}}{{x}_{3}} , y = \frac{{x}_{2}}{{x}_{3}} ] ,$$

where x₁, x₂ and x₃ are color space components of the pixel.

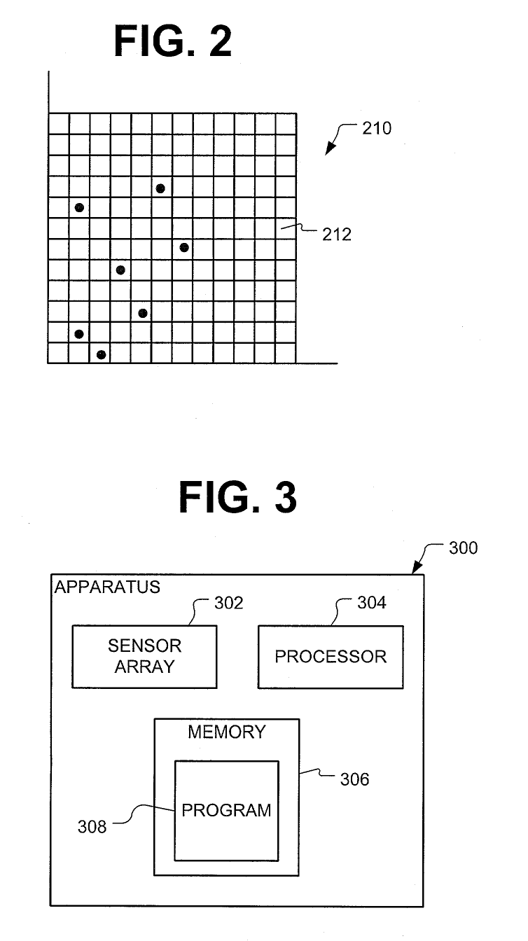

Additional reference is made to FIG. 2. A chromaticity histogram 210 is generated from the set of chromaticity vectors (114-116). The chromaticity space is divided into N×N bins 212 or entries, and a bin 212 of the histogram H_{W}(x,y) is filled if a chromaticity vector falls into that bin 212 (114). A filled bin 212 is indicated by a darkened circle (●). The bins 212 may be equally sized.

The value or weight of each histogram entry is determined as a function of pixel brightness (116). Each chromaticity entry in the histogram H_{W}(x,y) may be a real number having a value v, where 0≦v≦1. Each value v represents a measure of the likelihood that chromaticity (x, y) corresponds to a white surface. Thus entries of the histogram H_{W}(x,y) are zero if the corresponding chromaticity does not appear in the image, and otherwise take some value in the range (0, 1). When multiple pixels are mapped to the same chromaticity, the weight of the brightest pixel may be used, or the weight of the pixel having the highest frequency may be used, or the weight may be based on a robust maximum. The robust maximum may be the mean of the brightest n % of pixels falling into a bin. The brighter pixels are given more weight in a subsequent illuminant likelihood calculation.

An absolute measure of pixel brightness could be used to determine the weights of the histogram entries, but the absolute measure is likely to be somewhat unreliable if the intensity of the scene illumination is subject to large local variations across the extent of the scene (e.g., a typical outdoor scene that has sunlit and shaded regions). As an alternative, the histogram H_{W}(x,y) may be based not on the absolute brightness of a pixel but rather on pixel brightness relative to some local neighborhood of pixels.

The value v may be based upon a ratio of pixel brightness to local brightness. The local brightness may be an average brightness, maximum brightness or median brightness of the local neighborhood.

Consider the following example of computing a value v for an entry of the histogram H_{W}(x,y). A brightness ratio (BR) is computed as

$$BR = \frac{\sqrt{{R}^{2} + {G}^{2} + {B}^{2}}}{{\sum }_{i ∈ N} \sqrt{{R}_{i}^{2} + {G}_{i}^{2} + {B}_{i}^{2}}}$$

where N represents the neighborhood of pixels. The greater the value of this brightness ratio, the more likely it is that the corresponding pixel is white. For example, if the pixel values are in the range (ε . . . 1), then the maximum value of the brightness ratio is BR=\sqrt{3}/ε. Thus the pixel is deemed white if the maximum brightness ratio is obtained. In contrast if the brightness ratio is BR<1, then the pixel is deemed non-white.

As another example, a non-zero value is assigned to an entry if a brightness ratio falls within a range. A ratio q may be computed as q=B/B_{local} for a pixel B having a local brightness B_{local}. Let Bmin and Bmax represent the minimum and maximum possible pixel brightness. For an eight-bit word, Bmin may equal 0 and Bmax may equal 255. A ratio of q=1 would suggest a low probability that the pixel under consideration is white, whereas a ratio of q=255 would suggest with a very high probability that the pixel under consideration is white.

The ratio q may be used to compute the following probability:

$$P ( Pixel is white \vert q ) = 1 - P ( \frac{B min}{q} < Blocal < \frac{B max}{q} ) .$$

This represents the probability that a pixel is white, given that the ratio q is directly related to the probability of observing a pixel with brightness in the range

$$\frac{B min}{q} < Blocal < \frac{B max}{q} .$$

The weighted chromaticity histogram H_{W}(x,y) may be used to estimate the white point of scene illumination (118). A variety of techniques for estimating the white point of scene illumination may be used. For example, the weighted chromaticity histogram H_{W}(x,y) may be used with the following techniques: a Color-by-Convolution technique, a Color-by-Correlation technique, a Grey-world technique, and a Neural Network technique.

The Color-by-Convolution technique is disclosed in U.S. Ser. No. ______ filed ______ (attorney docket no. 100203092-1), which is incorporated herein by reference. The weighted chromaticity histogram H_{W}(x,y) may replace the chromaticity histogram H(x,y) such that

$$l ( {x}_{i} , {y}_{j} ) = {\sum }_{x} {\sum }_{y} {H}_{W} ( x , y ) {Q}_{{x}_{0} , {y}_{0}} ( {x}_{i} - x , {y}_{j} - y ) = {H}_{W} ( x , y ) ⊗ {Q}_{{x}_{0} , {y}_{0}} ( x , y ) .$$

An exemplary Color-by-Correlation technique is disclosed in U.S. Pat. No. 6,038,339. The weighted chromaticity H_{W}(x,y) is used to compute the log raw probabilities (l) as l=vector(H_{W}(x,y))m, where m is the log of the probability correlation matrix.

Grey-world techniques are disclosed in G. Buchsbaum, “A spatial processor model for object color perception”, Journal of the Franklin Institute 310, pp. 1-26 (1980); and Gershon et al., “From [R,G,B] to Surface Reflectance: Computing Color Constant Descriptors in Images”, Proceedings of the 10^{th} International Joint Conference on Artificial Intelligence, Milan, Italy, pp. 755-758 (1987). The white point may be determined by determining the average of the weighted chromaticity histogram H_{W}(x,y).

A Neural Network technique is disclosed in U.S. Pat. No. 5,907,629. The weighted chromaticity H_{W}(x,y) may replace the binary chromaticity histogram. The weighted chromaticity H_{W}(x,y) is then propagated through a neural network to find the white point.

Reference is now made to FIG. 3, which shows an apparatus 300 including a sensor array 302, a processor 304, and memory 306. Stored in the memory 306 is a program 308 that, when executed, instructs the processor 304 to process an image captured by the sensor array 302. The image is processed according to the method of FIG. 1. The apparatus 300 may be a digital camera, a video camera, etc.

The present invention is not limited to an apparatus including a sensor array. The apparatus may be a computer, a printer, a photo finishing system, etc.

The apparatus is not limited to the general-purpose processor and memory shown in FIG. 3. Other hardware implementations may be used to carry out the method of FIG. 1. For example, the apparatus may include a processor based on a state machine or other dedicated processor.

The digital images are not limited to images captured by sensor arrays. For example, a digital image may be a computer-generated image that was formed using one or more computer-simulated light sources.

Although the present invention was described in connection with RGB space, it is not so limited. Other usable color spaces include CMY, CMYG, Yc_{b}cᵣ, and Lab.

The present invention is not limited to the specific embodiments described above. Instead, the present invention is construed according to the claims that follow.

1. A method of determining the white point of scene illumination, the method comprising using a chromaticity histogram that is weighted for brightness.

2. The method of claim 1, wherein each entry in the chromaticity histogram is a real number having a value v, where 0≦v≦1.

3. The method of claim 1, wherein each entry in the chromaticity histogram represents a likelihood that the associated chromaticity corresponds to a white surface.

4. The method of claim 1, wherein histogram entries corresponding to brighter pixels have higher weights.

5. The method of claim 4, wherein when multiple pixels are mapped to the same histogram entry, the weight of the brightest pixel is used.

6. The method of claim 4, wherein when multiple pixels are mapped to the same histogram entry, the weight of the pixel having the highest frequency is used.

7. The method of claim 4, wherein when multiple pixels are mapped to the same histogram entry, the weight is based on a robust maximum.

8. The method of claim 1, wherein weights of histogram entries are based on local brightness relative to brightness of a pixel neighborhood.

9. The method of claim 8, wherein local brightness is determined as an average brightness of a pixel neighborhood.

10. The method of claim 8, wherein local brightness is determined as maximum brightness of a pixel neighborhood.

11. The method of claim 8, wherein local brightness is determined as a median brightness of a pixel neighborhood.

12. The method of claim 1, wherein entries in the chromaticity histogram are generated by determining a ratio of pixel brightness to local brightness for each pixel; and assigning a weight to each pixel based its corresponding ratio.

13. The method of claim 1, wherein each entry of the chromaticity histogram is generated as a probability that a corresponding pixel is white, the probability P(Pixel is white|q) determined as
$$P ( Pixel is white \vert q ) = 1 - P ( \frac{B min}{q} < Blocal < \frac{B max}{q} ) .$$

14. The method of claim 1, wherein the weighted chromaticity histogram is used in a Color-by-Correlation technique for white point estimation.

15. The method of claim 1, wherein the weighted chromaticity histogram is used in a Color-by-Convolution technique for white point estimation.

16. The method of claim 1, wherein the weighted chromaticity histogram is used in a Grey-world technique for white point estimation.

17. The method of claim 1, wherein the weighted chromaticity histogram is used in a Neural Network technique for white point estimation.

18. Apparatus for determining a white point of scene illumination, the apparatus comprising a processor for using a chromaticity histogram that is weighted for brightness.

19. The apparatus of claim 18, wherein each entry in the chromaticity histogram is a real number having a value v, where 0≦v≦1.

20. The apparatus of claim 18, wherein each entry in the chromaticity histogram represents a likelihood that the associated chromaticity corresponds to a white surface.

21. The apparatus of claim 18, wherein histogram entries corresponding to brighter pixels have higher weights.

22. The apparatus of claim 18, wherein weights of histogram entries are based on local brightness relative to brightness of a pixel neighborhood.

23. The apparatus of claim 18, wherein entries in the chromaticity histogram are generated by determining a ratio of pixel brightness to local brightness for each pixel; and assigning a weight to each pixel based its corresponding ratio.

24. The apparatus of claim 18, wherein each entry of the chromaticity histogram is generated as a probability that a corresponding pixel is white, the probability P(Pixel is white|q) determined as
$$P ( Pixel is white \vert q ) = 1 - P ( \frac{B min}{q} < Blocal < \frac{B max}{q} ) .$$

25. The apparatus of claim 18, wherein the processor uses the weighted chromaticity histogram in a Color-by-Correlation technique for white point estimation.

26. The apparatus of claim 18, wherein the processor uses the weighted chromaticity histogram in a Color-by-Convolution technique for white point estimation.

27. The apparatus of claim 18, wherein the processor uses the weighted chromaticity histogram in a Grey-world technique for white point estimation.

28. The apparatus of claim 18, wherein the processor uses the weighted chromaticity histogram in a Neural Network technique for white point estimation.

29. The apparatus of claim 18, further comprising a sensor array for generating a digital image of a scene under the illumination.

30. A computer program for instructing a processor to determine a white point of scene illumination, the program comprising instructions that, when executed, instruct the processor to generate and use a chromaticity histogram that is weighted for brightness.

31. The program of claim 30, wherein each entry in the chromaticity histogram is a real number having a value v, where 0≦v≦1.

32. The program of claim 30, wherein each entry in the chromaticity histogram represents a likelihood that the associated chromaticity corresponds to a white surface.

33. The program of claim 30, wherein histogram entries corresponding to brighter pixels have higher weights.

34. The program of claim 30, wherein weights of histogram entries are based on local brightness relative to brightness of a pixel neighborhood.
